(19) United States
(12) Patent Application Publication
(10) Pub. No.: US 2010/0088232 A1
(43) Pub. Date: Apr. 8, 2010

(54) VERIFICATION MONITOR FOR CRITICAL TEST RESULT DELIVERY SYSTEMS

(76) Inventor: Brian Gale, Bronx, NY (US)

Correspondence Address: TED SABETY, c/o Sabety +associates, PLLC, 1130 Bedford Rd., PLEASANTVILLE, NY, 10570, US

(21) Appl. No.: 12/408,686

(22) Filed: Mar. 21, 2009

Related U.S. Application Data
(63) Continuation-in-part of application No. 12/361,081, filed on Jan. 28, 2009.
(60) Provisional application No. 61/038,729, filed on Mar. 21, 2008.

(51) Int. Cl. G06Q 10/00; G06Q 50/00; H04L 9/00; G06F 15/16

(52) U.S. Cl. 705/50; 705/317; 705/3; 709/206; 709/227; 709/224

(57) ABSTRACT

A system and method for verification monitoring of a critical test result management (CTRM) system is provided. In one embodiment, the method includes receiving test result metadata pertaining to test result messages provided to a CTRM system by a diagnostic test facility, verifying compliance of the diagnostic test facility with prescribed usage of the CTRM system using the test result metadata, and sending a message to an interested party regarding whether or not compliance of the diagnostic test facility has been verified.

This application claims priority to U.S. Patent Application No. 61/038,729 filed Mar. 21, 2008, which is incorporated herein by reference, and is a continuation in part to U.S. patent application Ser. No. 12/361,081 filed on Jan. 28, 2009, which is incorporated herein by reference.

### FIELD OF THE INVENTION

The present invention relates to computer information systems, and more particularly relates to a system and method for monitoring and assembling metadata related to critical test result delivery systems.

### BACKGROUND OF THE INVENTION

Medical testing and imaging technologies and procedures are playing an increasingly critical role in diagnostic decision-making. For example, the last several years have witnessed a geometric increase in the volume of diagnostic radiology examinations performed. Owing to the increased number of examinations, radiologists are discovering a growing number of significant findings each year. However, not all finding are reported or provided to other clinicians in a timely and accurate manner so as to enable proper diagnosis and treatment.

In fact, the failure to report radiological findings can result in liabilities for the practitioner, and is becoming a prevalent cause of malpractice litigation. The currently adopted community standard of care requires that radiologists report all urgent and/or unexpected (i.e., significant and/or critical) findings directly to the referring clinician. The duty to report directly to the clinician is considered to be a distinct obligation, not necessarily fulfilled by reporting the finding in a diagnostic report of an imaging procedure. In light of the importance of timely reporting of diagnostic testing results to the treating clinician, a number of medical associations have issued recommendations requiring hospitals to document direct communication of critical test results from diagnostic services including radiology and pathology.

Because “failure to report” carries a high risk of liability, malpractice insurance carriers that are exposed to such liability have a significant interest in confirming that diagnostic services report critical test results directly to clinicians. It has been found that when critical tests are reported directly and in a timely manner, the amount of malpractice litigation significantly decreases. The reduction in assessments against insurance carriers can be passed on in terms of lower insurance cost to medical practitioners.

What is needed is a system and method to ensure that the reporting of diagnostic test information directly to the clinician occurs consistently and continually, allowing insurance carriers be confident of mitigation in risks associated with such procedures.

### BRIEF DESCRIPTION OF THE DRAWINGS

FIG. 1A is a block diagram of a system for verification monitoring of a CTRM system according to an embodiment of the present invention.

FIG. 1B is a block diagram of an alternative embodiment of a system for verification monitoring of a CTRM system according to the present invention.

FIG. 1C is a block diagram of another alternative embodiment of a system for verification monitoring of a CTRM system according to the present invention.

FIG. 2 is a flow chart of a method of verification monitoring of a CTRM system according to an embodiment of the present invention

FIG. 3 is an illustration of extracted test result metadata according to an embodiment of the present invention.

### DETAILED DESCRIPTION

Critical test result management (CTRM) is a set of computer-executable procedures that automates delivery, store and confirmation of test results from reporting physicians, who perform diagnostic test, such as X-ray, MRI (Magnetic Resonance Imaging), PET (Position Emission Tomography), blood chemistry, pathology, genetic tests, etc., to clinical physicians who use the test results to perform diagnoses.

One example of a CTRM system is the Veriphy™ produced by Nuance Communications. After a diagnostic test has been completed, a reporting physician may contact the Veriphy™ operating on one or more computer servers via phone, email or access using an Internet web-page to report the test results in a ‘test result message’ or operation of an application where the test results are entered on one computer system and transmitted and stored at another. The test result message may include an indication of the importance or urgency of the test results. Upon receipt of a test result message from the reporting physician, a computer server executing Veriphy™ or other CTRM software stores the message and generates alerts to the clinical physician who ordered the test that the test results have been received. The alert may also include an indication of relative importance/urgency of the test result. The alert to the clinical physician may take a variety of forms including a pager message, a call to a cell phone, an email to a computer or portable computing device, instant message, interprocess communication between computer systems managing the process and a system the physician is viewing or any other kind of electronic communication that provides notice to the physician, depending on the notification preferences the clinical physician registers with the CTRM system.

Once the clinician physician becomes aware of the alert, the clinician can access the stored test result message via the CTRM system, after which the system generates and sends a confirmation message back to the reporting physician that the test result message has been retrieved by the clinical physician, and also creates a legal record that the ‘loop’ from the reporting physician to the clinical physician back to the reporting physician has been closed. When all participants (reporting physicians, clinical physicians, administrators, other personnel) use the system regularly in the prescribed manner, it has been found that test results are analyzed more quickly, and errors such as misplaced of test results are avoided, reducing risks of medical malpractice liability.

While the Veriphy™ system and similar CTRM systems have proven very valuable to hospital administrators, they are not fool proof; while they do an outstanding job of monitoring the performance of the clinical physician with regard to how quickly results are retrieved and acted upon, they do not monitor the performance of the reporting physician. In other words, a reporting physician may sit on test results for an unduly long period, or may report results by a more traditional method, bypassing the CTRM system. Conventional CTRM systems would have no way of recognizing this shortfall in medical service performance. This difficulty can compromise the risk-reduction benefits of the CTRM system as a whole.

The present invention seeks to solve this problem by providing a mechanism whereby the compliance of reporting physicians at a diagnostic facility with prescribed CTRM procedures and usage by reporting physicians of a CTRM on a regular basis may be verified. To this end, the present invention provides a system and method in which information concerning critical test result messages from a selected group of one or more reporting physicians, hereinafter referred to as ‘test result metadata’, is captured from a CTRM system and stored. The test result metadata may be reported directly to interested parties such as insurance carriers and the test result metadata may be analyzed to calculate usage metrics and to determine CTRM usage patterns for the reporting physicians. In some embodiments, the analysis of usage patterns may indicate whether usage of the CTRM system at a particular diagnostic facility has fallen below a threshold according to a metric of usage.

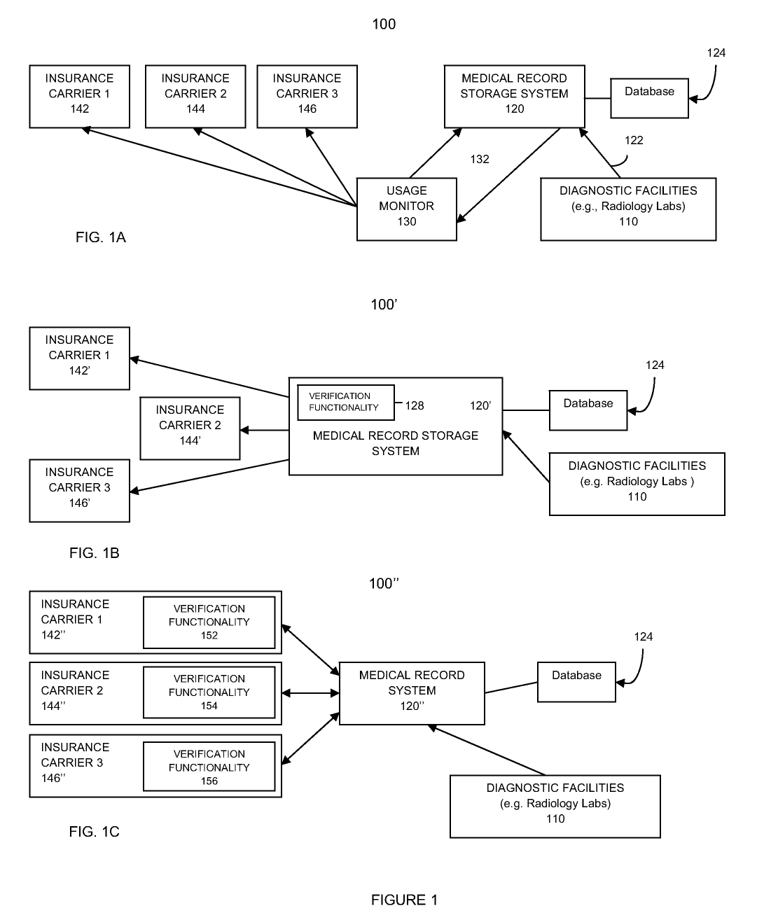

FIG. 1A is a block diagram of one embodiment of a system 100 for verification monitoring of a CTRM system according to an exemplary embodiment of the present invention. One or more diagnostic testing facilities, shown collectively as block 110 are communicatively coupled to a medical records storage system 120 by one or more, but show collectively as a communication link 122 which may take the form of a wired or wireless telephone link or a data communication link over the Internet, or a wide/local area network or any other communication mode through which a reporting physician may instantaneous transmit a test result message to the medical records storage system 120. The medical records storage system 120, which may reside at or separately from a clinical facility, may comprise a computer system that implements and executes CTRM software, such as Veriphy™. In some embodiments the medical records storage system comprises a medical records server coupled to a database 124 in which medical records, including received test result messages, are stored. Through implementation of the CTRM system, the medical records storage system 120 may interact with clinical physicians at one or more clinical facilities (not shown).

According to an embodiment of the present invention, a third-party usage monitor 130 is also communicatively coupled to the medical record storage system 120. The communication link 132 may be implemented in a number of ways including a direct or remote interface to the database 124, coupling (e.g., ‘hooking’) to an application program interface (API) of a CTRM client or web browser, via FTP or other data transmission protocol and/or via encrypted email. Directing interfacing to the CTRM database 124 allows data to be downloaded rapidly from the database 124. Practitioners of ordinary skill will recognize that the third-party usage monitor can be also or alternatively coupled to the diagnostic physicians systems in order to monitor metadata associated with message transmissions being sent to the medical record database. The usage monitor 130 is configured to perform the method of verification monitoring according to the present invention and, in particular, is adapted to extract test result metadata from the database 124 or from the diagnostitian's systems. As described more fully below the usage monitor may also be configured to analyze the test result metadata. The usage monitor 130 is communicatively coupled to the computer systems operated by or on behalf of one or more insurance carriers 140, 142, 144 (there may be any number of insurance carriers) via a data network or telephonic communication links Preferably, the communication link 148 is a secure data communication link such as a virtual private network (VPN) that allows rapid uploading of test result metadata from the usage monitor to computer systems of the respective one or more insurance carriers 140, 142, 144. In another embodiment, the third-party usage monitor system receives the metadata about data traffic as it is occurring.

FIG. 1B shows an alternative embodiment of a system 100′ for verification monitoring of a CTRM system according to the present invention according to the present invention in which computer-executable software 128 adapted to perform reporting verification functions is implemented by the CTRM at the medical records storage system 120′. In this embodiment, the medical storage system 120′ provides verification of CTRM usage directly to the computer systems operated by or on behalf of insurance carriers 142′, 144′, 146′ by a secure communication method.

FIG. 1C shows another alternative embodiment of a system 100″ for verification monitoring of a CTRM system according to the present invention in which computer-executable software adapted to perform reporting verification 152, 154, 156 functions is implemented by the insurance carriers 142″, 144″, 146″ which are securely communicatively coupled to the medical records storage system 120″ so as to access CTRM reporting data.

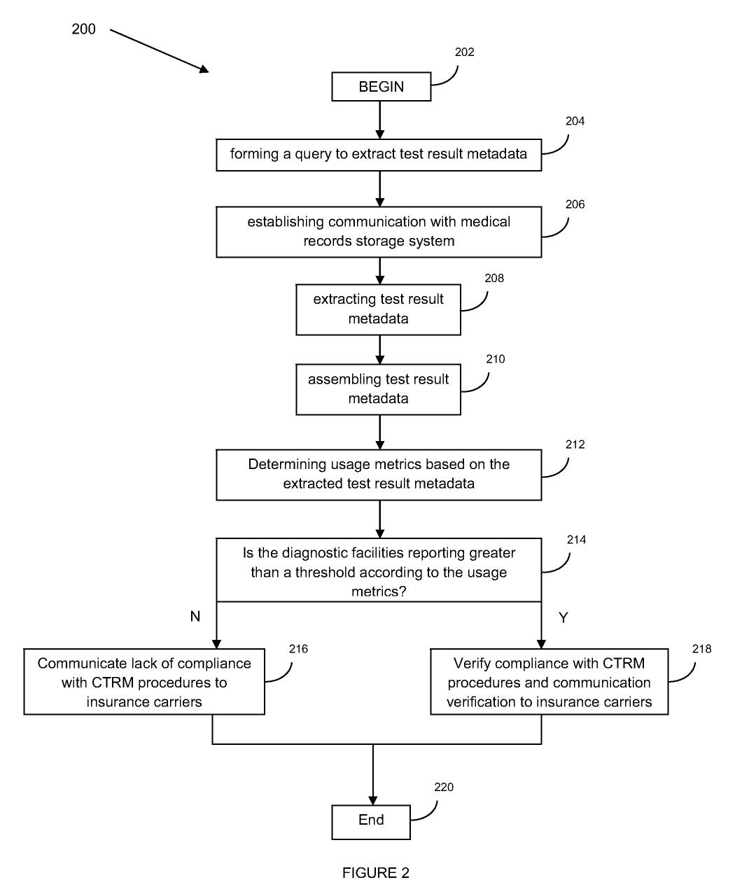

Methods for verification monitoring of a CTRM system verification according to the present invention will now be described. As shown in the flow chart of FIG. 2A, a first embodiment of the method 200 for verification monitoring of a CTRM system (which corresponds to the system illustration of FIG. 1A) begins in step 202. In step 204, the usage monitor forms a query or other type of request message identifying the diagnostic facility 110 for which CTRM test result metadata is sought. The query may be implemented as a SQL or SQL like query command for accessing the database 124. In step 206, the usage monitor 130 establishes communication with the medical records storage system 120 by one of the techniques discussed above and the query/request is delivered to the database 124 thereby. In step 208, the pertinent test result metadata is extracted from the database 124 and received (via the communication link 122) by the usage monitor 130. The test result metadata is then compiled or otherwise assembled in step 210 in a useful form to facilitate further processes. In some embodiments, the test result metadata is redacted to comply with various regulations, such as the Health Information Portability and Accountability Act (HIPAA) for protecting private health information. Individual patient identifiers may be removed from the test result metadata and replaced with anonymous index numbers to distinguish separate patients for quantification purposes. The metadata may contain identifiers indicating the identity of the diagnostic practice, the diagnostic physician, the clinician and the clinicians practice, or a combination of any one or a group of these. In addition, where the third party usage monitor system is integrated with more than one insurance carrier system, the metadata can contain an identity of the associated insurance carrier or carriers with the practices identified. In another embodiment, the third party usage monitor system can maintain a database that maps the identity index of a physician or practice with the associated malpractice insurance carrier.

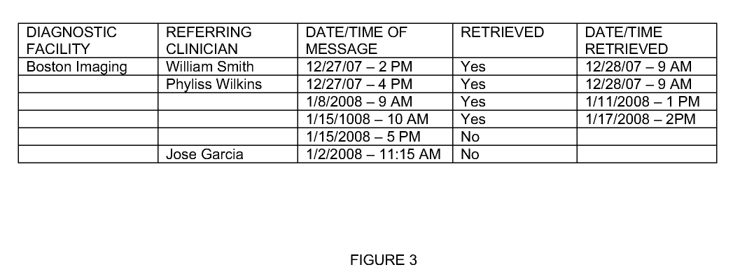

An exemplary sample of test result metadata extracted from the CTRM system by the usage monitor 130 is shown in FIG. 3. As indicated the test result metadata is presented as a table including an identifier of the diagnostic facility 110 conducting the relevant test, the clinical physician to whom a test result message is directed, dates/times when the test result message was sent, whether the clinical physician to whom the test result message is directed has retrieved the message, and the time of any such retrieval. The test result metadata tabulated in this way provides an indication of the number of test result messages sent by diagnostic facilities over time, as well as records rates of retrieval by the clinical physicians. These metadata data records can be stored in a database, either at the medical record database of the clinical practice, the third party usage monitor or at the systems of the insurance carrier. Each row in the chart shown in FIG. 3 represents a transaction within the CTRM system: it has a record of when a diagnostic report has been delivered and when such report has been reviewed. In another embodiment, the metadata can include, for each transaction, information about the request for diagnostic service itself. For example, the requesting physician can use the CTRM system to transmit test data to the diagnostician, including appropriate patient identifying information. In this way, the CTRM system can also verify how well the diagnostic facility is responding to incoming requests. In this case, the transaction data would include a data and time stamp associated with the request for diagnostic service.

In some embodiments, usage metrics based on the test result metadata are determined in step 212. The usage metrics may include a variety of parameters obtained through analysis of the test result metadata. For example, a number of test result messages submitted by the diagnostic facility 110 to the CTRM system for one or more patients over a 3-month period or some other pre-determined period and also over individual weeks or some other second pre-determined period within the 3-month period may be calculated. The average reporting over the 3-month period may then be divided to yield an average weekly reporting figure. In this manner, a first metric represented by an average number of reports calculated over a long duration, and second metrics represented by actual weekly numbers of reports are generated. These metrics can be compared to a pre-determined threshold. When the usage monitor system detects that the metric has crossed the pre-determined threshold, an alert can be generated as an electronic message that is delivered to the appropriate practice management or insurance carrier personnel, by means of pager, email, instant message, interprocess communication or any other commonly used form of electronic communication. Another metric is the measurement of average time to respond to the delivery of the diagnostic message. Another metric is measurement of the average time to respond to a request to review a diagnostic measurement. Another metric is the number or percentage of requests for diagnostic services that are not responded to. Another metric is the number or percentage of dagnostic result deliveries that are not responded to at all. The different metrics can be compared to detect discrepancies in usage of the CTRM system by the reporting physicians over time. It is noted the foregoing example is exemplary, and that additional and/or different metrics may be determined and employed. The metrics and instances of threshold crossing can be stored in a database for later retrieval and review.

In some embodiments of the present invention, in step 214, the metrics may be employed to determine whether the diagnostic facility 110 is deficient in reporting to the CTRM system, which may be done, for example, by determine whether recent short term reporting figures fall below longer term average reporting figures by a threshold amount, indicating a decrease in the level of reporting at the diagnostic facility 110 (assuming the number of tests performed of the diagnostic facility remain approximately the same over the same period). The threshold amount may be set in different ways, possibly according to risk assessments made by the insurance carriers 142, 144, 146.

If it is determined (in step 214), that the reporting of the diagnostic facility is below the threshold, the usage of the CTRM is not verified, and in step 216, the usage monitor 130 makes a record of the deficiency and may send an encrypted message or otherwise communicate this to the insurance carriers by means of electronic message transmission, 142, 144, 146. If is determined (in step 214), that reporting of the diagnostic facility is above the threshold, the usage monitor makes a record of compliance and sends a message or other type of communication to the insurance carriers 142, 144, 146 certifying compliance that the diagnostic facility 110 is complying with the prescribed procedures for usage of the CTRM system. The method ends in step 220. Usage reports (in either case) may be sent to the insurance carriers 142, 144, 146 and/or other interested parties by file transfer protocol (FTP), printed records that are mailed, telephonic reporting, fax and/or encrypted email among other secure techniques.

The above-described method is intended to be performed on a regular basis, so that test result metadata is continually updated and monitored, so any shortfalls in reporting can be detected quickly and possibly remedied. In another embodiment, the metadata can be collected, stored and analyzed on demand. In another embodiment, the metadata can be continually created and monitored as the CTRM system is being used.

In other embodiments, the verification monitoring is performed at other entities such as the medical records storage system 120′ (FIG. 1B) or on the systems operated by the insurance carriers 142″, 144″, 146″ (FIG. 1C) or other interested parties authorized to acquire test result metadata. In these embodiments, the method discussed above is modified accordingly. For example, when the medical records storage system 120′ (FIG. 1B) executes the verification monitoring functions according to the present invention, it does not need to establish communications with itself in order to retrieve test result metadata from database 124. Similarly, when the insurance carriers 142″, 144″, 146″ (FIG. 1C) executes the verification monitoring functions according to the present invention, the insurance carriers 142″, 144″, 146″ may determine the compliance of the diagnostic facilities, and thus no separate verifications or certifications need to be sent to the carriers 142″, 144″, 146″ from a third party. Other analogous modifications may be made as would be understood by those of skill in the art.

Communications between the systems can be encrypted to protect the data using typical encryption techniques well known in the art, including SSL (Secure Sockets Layer) and the like. Similarly, log-in procedures can include presenting a password unique to the referring physician or the interpreting physician or the imaging center. Practitioners of ordinary skill will recognize that password systems can include multiple passwords for each of these parties to address the fact that the referring physician may in fact be a large practice with multiple staff members. Practitioners of ordinary skill will recognize that known password protections include using biometric data of the user, for example, fingerprints, in order to access data.

A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In this disclosure “computer system” is meant to include one or more computers and other devices that are operably connected by means of such inter-process communication, or other data exchange protocols and is not limited to a single computer. The computers comprising the computer system may be located physically proximate or geographically distributed.

In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. Data items that are transmitted may be transmitted in one or more data packets or as a continuous stream of data. The act of “transmitting” may encompass the transmission of one or more data packets in a series of transmissions. The act of “receiving” may be the receipt of one or more transmissions.

Practitioners of ordinary skill will recognize that the data entries in the data packet may be address pointers to the actual data rather than the data themselves, that is, a communication between processes may provide the receiving computer an address pointer that tells the computer where to find the data representing the item, rather than providing the data item itself. In this disclosure, the term “data representing” an item is meant to include either mechanism: that is, an address specifying a location where the data object is stored or may be obtained or the data object itself.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the JO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The software logic components may, generally, be implemented in hardware as hardware logic circuits, if desired, using conventional techniques.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed by data transmission from a server or electronic bulletin board over a data communication network (e.g., the Internet or World Wide Web.)

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the figure is intended only to provide an extremely detailed disclosure of the present invention and is not intended to be limiting.

Accordingly, while the present invention has been disclosed in connection with exemplary embodiments thereof, it should be understood that other embodiments may fall within the spirit and scope of the invention, as defined by the following claims.

What is claimed is:

1. A method of verification monitoring of a critical test result management (CTRM) system comprising:
Obtaining either by receiving from a database operator or retrieving from a database test result metadata from stored test result messages;
Verifying compliance of the diagnostic test facility with prescribed usage of the CTRM system using the test result metadata; and
Sending a message to an interested party regarding whether or not compliance of the diagnostic test facility has been verified.

2. The method of claim 1, further comprising:
determining usage metrics from the test result metadata;
wherein the usage metrics are used to verify compliance of the diagnostic test facility.

3. The method of claim 2, wherein the step of verifying compliance includes:
determining whether the usage metrics indicate that the usage of the CTRM system by the diagnostic facility is above a threshold;

4. The method of claim 3, wherein the threshold is set by an insurance carrier according to a risk assessment.

5. The method of claim 2, wherein the usage metrics include usage statistics of the CTRM system by the diagnostic facilities over different durations of time.

6. The method of claim 1, further comprising:
removing private health information from the test result metadata.

7. The method of claim 1, wherein the steps of receiving, verifying and sending are performed by a third party usage monitor.

8. The method of claim 1, wherein the steps of receiving, verifying and sending are performed by a third party usage monitor.

9. The method of claim 8, further comprising:
before extracting test result metadata, establishing data communication with a medical records storage system in which the CTRM system is implemented.

10. The method of claim 9, wherein data communication between the medical record storage system and the third party usage monitor is encrypted.

11. The method of claim 1, wherein the steps of extracting, verifying and sending are performed by a medical records storage system at which the CTRM is implemented.

12. A computer system adapted to perform a method of verification monitoring a CTRM system, the computer system comprising:
a data communication device coupled to a data communication link;
a processor adapted to:
establish data communication over the communication link with a medical records storage system at which a CTRM system is implemented using the data communication device;
extract test result metadata pertaining to a diagnostic test facility from the CTRM system;
verifying compliance of the diagnostic test facility with prescribed usage of the CTRM system using the test result metadata; and
sending a message to an interested party regarding whether or not compliance of the diagnostic test facility has been verified using the data communication device.

13. The computer system of claim 12, wherein the processor is further adapted to determine usage metrics from the test result metadata, the usage metrics being used to verify compliance of the diagnostic test facility.

14. The computer system of claim 13, wherein the processor is further adapted to determine whether the usage metrics indicate that the usage of the CTRM system by the diagnostic facility is above a threshold.

15. A computer system adapted to perform a method of verification monitoring a CTRM system, the computer system comprising:
a data communication device coupled to a data communication link;
a processor adapted to:
extract test result metadata pertaining to a diagnostic test facility from the CTRM system;
verifying compliance of the diagnostic test facility with prescribed usage of the CTRM system using the test result metadata; and
sending a message to an interested party over the communication link regarding whether or not compliance of the diagnostic test facility has been verified using the data communication device.

16. The computer system of claim 15, wherein the processor is further adapted to determine usage metrics from the test result metadata, the usage metrics being used to verify compliance of the diagnostic test facility.

17. A method of verification monitoring of a critical test result management (CTRM) system comprising:
extracting test result metadata from stored test result messages provided to a CTRM system by a diagnostic test facility;
calculating usage metrics based on the test result metadata; and
verifying compliance of the diagnostic test facility with prescribed usage of the CTRM system based on whether the usage metrics indicate that the diagnostic facility is using the CTRM system more than a threshold level.

18. A method verifying use of a CTRM system comprising:
Receiving a plurality of metadata elements, each element containing information describing one or more CTRM system transactions;
Calculating a CTRM usage metric using data contained within said received metadata elements;
Storing said calculated usage metric.

19. The method of claim 18 further comprising:
Determining whether the calculated usage metric meets a predetermined criteria;
Storing a value representing the outcome of such determination.

20. The method of claim 19 further comprising:
Transmitting a data message whose content is a function of the stored value.
